(19) United States
(12) Patent Application Publication
(10) Pub. No.: US 2004/0083470 A1
(43) Pub. Date: Apr. 29, 2004

(54) Information updating apparatus, information updating method and recording medium for recording information updating program

(75) Inventors: Tadao Michimura, Kawasaki-shi (JP); Tadahiko Ikegaya, Kawasaki-shi (JP); Keiko Shiraishi, Kawasaki-shi (JP); Akira Hirose, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/385,627

(22) Filed: Mar. 12, 2003

(30) Foreign Application Priority Data
Oct. 29, 2002 (JP) 2002-315009

(51) Int. Cl. G06F 9/44

(52) U.S. Cl. 717/168; 707/200; 379/457

(57) ABSTRACT

The present invention updates only necessary information alone, while decreasing the user's load of operation, without executing complex processing. A service-retrieving server searches for a FAX service that is currently available. A concentrated-management section displays on a GUI the searched result of the service-retrieving server. And the management section collectively updates a FAX number table that is commonly used by a respective one of the service-processing devices that appear in a FAX service list.

### BACKGROUND OF THE INVENTION

1. Field of the Invention

The present invention relates to an information updating apparatus, information updating method, and recording medium for having recorded thereon information updating program and, more particularly, to an information updating apparatus, information updating method, and recording medium for having recorded thereon an information updating program which each update common information that is used in a plurality of service-processing devices.

2. Description of the Related Art

There has hitherto been proposed a technique which, by performing the installing operation with respect to a server machine once, enables updating all client machines' software in the system (for example see Japanese Patent Publication No. 1: JP-A No. 6-309261).

Also, there has been proposed, too, a technique which performs version-up of a copying machine prepared by installing a plurality of functions, such as a printer, scanner, facsimile, copier, etc., collectively into the interior of one piece of device (for example Japanese Patent Publication No. 2: JP-A No. 2001-337817).

However, in each of the techniques described in the Patent Publications Nos. 1 and 2, there was the problem that it was necessary to recognize the software that became an object that is to be updated, and the version information of the composite machine; and it was also necessary to use a procedure of performing individual and separate updating of relevant-device information every service. Further, there was also the problem that, even when the operator wanted to update only necessary information alone, he had to perform individual and separate updating of information about those respective relevant devices.

### SUMMARY OF THE INVENTION

The present invention has been made in order to solve the above-described problems and has an object to provide an information updating apparatus, information updating method, and recording medium for having recorded thereon information updating program which each enable updating only necessary information without executing complex processing operations and while the operator's operation load is being decreased.

An information updating apparatus in the first aspect of the invention comprises a service content receiving section for receiving each content of service, which has been transmitted from a plurality of service-processing devices that provide a service for executing a predetermined processing on document data; a retrieving section for retrieving, based on the content of service that has been received from the service content receiving section, the service-processing device that uses predetermined common information; and an updating section for collectively updating the common information for the service-processing device that was searched for by the retrieving section.

An information updating method in the fourth aspect of the invention comprises receiving service content that has been transmitted from each of a respective one of a plurality of service-processing devices that provide a service for executing a predetermined processing on document data; retrieving, based on the content of service that was received in the service content receiving step, for the service-processing device that uses predetermined common information; and collectively updating the common information with respect to the service-processing device that was searched for in the retrieving step.

A recording medium in the seventh aspect records an information updating control program for causing a computer to execute a processing, which comprises the steps of: receiving each content of service that has been transmitted from a plurality of service-processing devices that each provide a service for executing a predetermined processing on document data; retrieving, based on the content of service that has been received in the service content receiving step, for the service-processing device that uses predetermined common information; and collectively updating the common information with respect to the service-processing device that was searched for in the retrieving step.

In the first, fourth, and seventh aspects of the invention, the service-processing device executes services such as copy, mail transmission, facsimile, image processing, etc. with respect to document data. The contents, number, etc. of the services that the service-processing device provides are not limited. Also, the “document data” needs only to be information associated with a document and includes, but not particularly limited to, letter information such as text data, and image information obtained by reading a paper document. The service content receiving section receives the content of service that has been transmitted from the above-described service-processing device.

The retrieving section searches for the service-processing device that uses predetermined common information according to the content of service that has been received by the service content receiving section. Here, the wording “predetermined common information”, preferably, is information that is commonly usable by the respective service-processing devices and is, for example, power setting information and user account information that is used to set permission or non-permission of use of the service.

The updating section collectively updates the common information with respect to the service-processing device that has been searched for by the retrieving section. Incidentally, the updating section may update the whole of the common information or may update only changed portions, alone, of the common information.

Accordingly, in the first, fourth, and seventh aspects of the invention, by retrieving for the service-processing device that uses predetermined common information according to the content of service that has been transmitted from the service-processing device and collectively updating the common information with respect to the service-processing device that has been searched for, it becomes unnecessary to individually update the common information that is used by each of the service-processing devices and it becomes possible to lessen the load that is applied upon the operator.

An information updating apparatus in the second aspect of the invention is constructed in a form wherein in the first aspect of the invention the retrieving section searches for the service-processing device that uses destination information as the common information.

An information updating method in the fifth aspect of the invention is constructed in a form wherein in the fourth aspect of the invention the retrieving step searches for the service-processing device that uses destination information as the common information.

An information updating control program in the eighth aspect of the invention is constructed in a form wherein in the seventh aspect of the invention the retrieving step searches for the service-processing device that uses destination information as the common information.

In the second, fifth, and eighth aspects of the invention, the invention uses destination information as the common information. The destination or addressee information includes, for example, a FAX number and an electronic mail address.

An information updating apparatus in the third aspect of the invention of the invention is constructed in a form wherein in the first or second aspect it further comprises a display section for displaying the common information, which is used by the service-processing device that was searched for by the retrieving section; and an editing section for editing the common information that was displayed by the display section, wherein the updating section collectively updates the common information that was edited by the editing section.

An information updating method in the sixth aspect of the invention is constructed in a form wherein in the fourth or fifth aspect it further comprises the steps of: displaying the common information that is used by the service-processing device, which was searched for in the retrieving step; and editing the common information, which was displayed in the display step, wherein the updating step collectively updates the common information that was edited in the editing step.

An information updating control program in the ninth aspect of the invention is constructed in a form wherein in the seventh or eighth aspect of the invention it further comprises the steps of: displaying the common information that is used by the service-processing device, which was searched for in the retrieving step; and editing the common information that was displayed in the display step, wherein the updating step collectively updates the common information that was edited in the editing step.

In the third, sixth, and ninth aspects of the invention, the display section displays the common information that is used by the service-processing device that has been searched for in the retrieving section. The editing section edits the common information that has been displayed in the display section. Here, the display section and editing section include, although not particularly limited to, a keyboard, a pointing mouse, and a touch panel. And the updating section collectively updates the common information that has been edited by the editing section.

Accordingly, in the third, sixth, and ninth aspects of the invention, by displaying the common information that is used by the service-processing device that has been searched for by the retrieving section, editing the common information that has been displayed, and collectively updating the common information that has been edited, the operator can do away with the labor of individually updating the common information that is used by each of the service-processing device, by performing his editing operation only once.

### BRIEF DESCRIPTION OF THE DRAWINGS

FIG. 1 is a block diagram illustrating the construction of a document-processing system according to an embodiment of the present invention.

FIG. 2 is a block diagram illustrating the functional constructions of composite machines, facsimile device, service-retrieving server, and concentrated-management server that are provided with respect to the document-processing system.

FIG. 3 is a view illustrating the construction of I/F information stored in the I/F information-registering section.

FIG. 4 is a view illustrating a concentrated-management screen that is displayed on a GUI of the concentrated-management server.

FIG. 5 is a flow chart illustrating an operational procedure of the concentrated-management server when a FAX number table is updated.

FIG. 6 is a view illustrating a FAX display list screen that has been displayed on the GUI.

FIG. 7 is a view illustrating a FAX number table screen that is displayed on the GUI.

### DETAILED DESCRIPTION OF THE PREFERRED EMBODIMENTS

Hereinafter, a preferred embodiment of the present invention will be explained in detail with reference to the drawings.

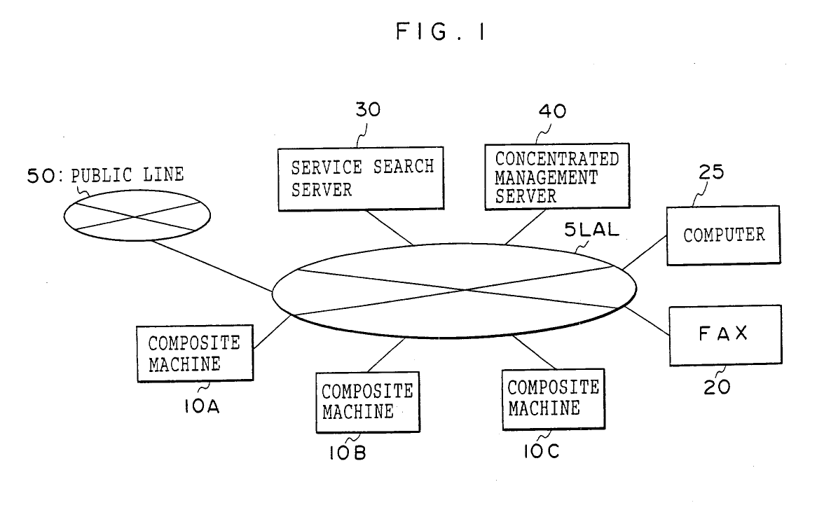

FIG. 1 is a block diagram illustrating the construction of a document-processing system 1 according to an embodiment of the invention.

The document-processing system 1 is the one wherein various services and applications have been connected thereto via a LAN 5. Here, the term “service” means functions that each regard a document and that, according to a request made from the outside, can each be utilized, such as copying, printing, scanning, facsimile transmission/reception, mail transmission, storage and read-in of data with respect to a repository, OCR (Optical Character Recognition) processing, and noise elimination processing.

The document-processing system 1, concretely, comprises composite machines 10A, 10B, 10C, . . . that each execute service processing of copy, print, scan, and facsimile, a facsimile device 20, a computer 25 that has a facsimiling modem and that has installed therein software for realizing the facsimile transmission/reception, a service-retrieving server 30 that searches for a service that an operator requests, and a concentrated-management server 40 that performs concentrated management of respective service-processing devices that are connected to a LAN 5. Further, the document-processing system 1 is connected to a public line 50 via the LAN 5.

Although the document-processing system 1, in this embodiment, has a construction wherein a plurality of servers each executing a predetermined service processing are connected via the LAN 5, only if a plurality of servers are connected via the LAN 5, no particular limitation is imposed upon the structure of the hardware. Also, although, in this embodiment, the explanation will be given by taking up as the service-processing devices the composite machines 10A, 10B, 10C, . . . facsimile device 20, and computer 25 equipped with facsimile transmission/reception functions, the invention is not limited thereto. For example, the service-processing device may be a copier, server, or computer that executes predetermined processing with respect to document data.

Incidentally, in the following explanation, when reference is made to a given one piece of the composite machines 10A, 10B, 10C, . . . , that one piece of device is defined as being represented by “the composite machine 10”.

The respective service-processing devices of the document-processing system 1 each execute a predetermined service while they are in co-operation with one another according to a predetermined written instruction. Here, the wording “written instruction” means data that, in a case where a series of processing steps are divided into a plurality of functional processing steps, contains therein information representing the relationship between the functions and the information (interface information) for retrieving a respective one of those functions. Further, that data may contain therein information for constructing a graphical user interface (GUI) concerning that series of processing steps. Further, the wording “in co-operation with” means that one service, for example, has a kind of relationship between it and another service in the way in which the result of the former service determines a service that is going to be subsequently started or has effect upon the operation of the latter subsequent other service.

The composite machine 10 performs four, copying, printing, scanning, and facsimiling, service-processing operations. Also, the composite machine 10 has a co-operation starting function to select a written-instruction data item according to the operator's operation, to input a parameter, and, by reflecting the parameter that has been input as data of the written instruction, to request start of co-operation processing.

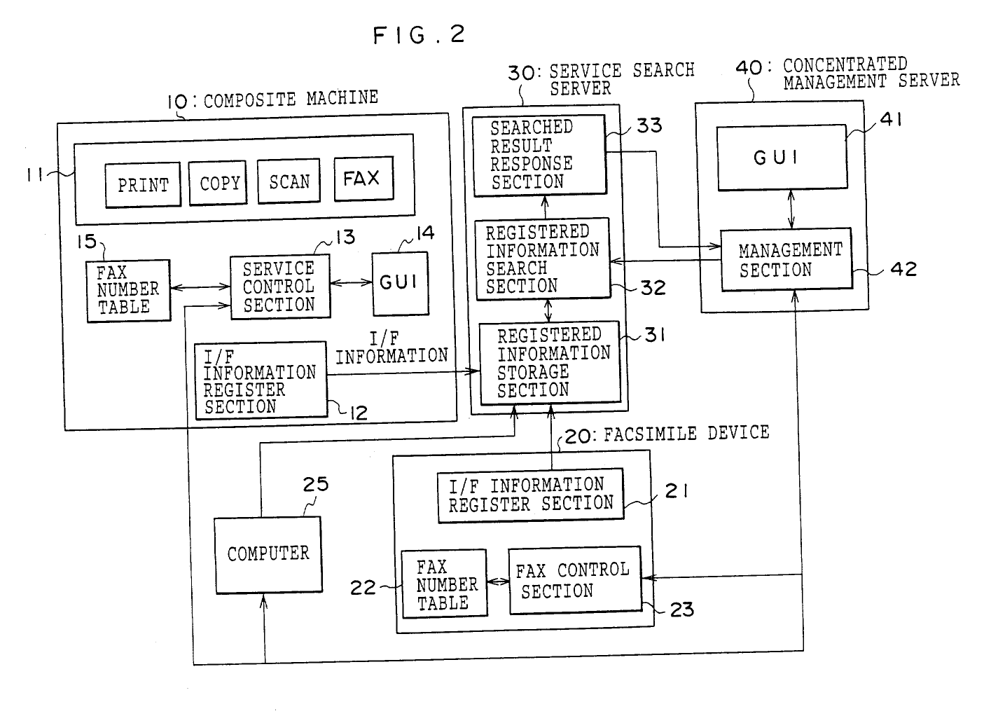

FIG. 2 is a block diagram illustrating the functional constructions of composite machines 10, facsimile device 20, computer 25 having a function to facsimile, service-retrieving server 30, and concentrated-management server 40 that are provided with respect to the document-processing system 1.

The composite machine 10 is equipped with a service-providing section 11 that performs copying, printing, scanning, and facsimiling service processing, an I/F information registering section 12 that stores therein interface information (hereinafter referred to as “the I/F information”) and registers it into a service-retrieving server 30, a service control section 13 that controls the service-providing section 11, a graphical user interface (GUI) 14 that displays the written instruction or performs predetermined operations, and a FAX number table storage section 15 that stores therein a FAX number table consisting of transmission destination names of facsimiling original documents, FAX numbers, etc.

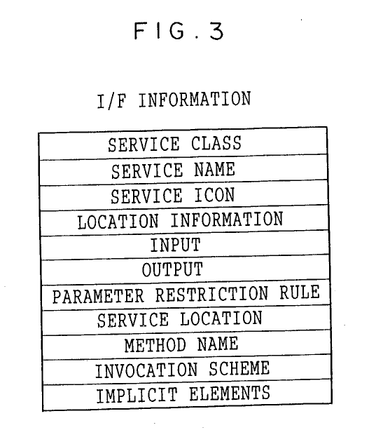

FIG. 3 is a view illustrating the construction of I/F information stored in the I/F information registering section 12. The I/F information is constructed of <Service Class>, <Service Name>, <Service Icon>, <Service Info Location>, <Input>, <Output>, <Parameter Restriction Rules>, <Service Location>, <Method Name>, <Invocation Scheme>, and <Implicit Elements>.

The <Service Class> declares services that the composite machines 10, which are service-processing devices, provide and the classes of the information that the services need to use. Incidentally, as the <Service Class>, there is used the one which is defined beforehand and which includes, for example, scan, print, repository, and flow.

The <Service Name> declares the names of the services that the composite machines 10, which are service-processing devices, provide. As the <Service Icon>, there are declared the positions of the icons that are used when making GUI display of the written-instruction data.

The <Service Info Location> declares the URLs which are used when the service-retrieving server 30 gets the I/F information. The <Method Name> declares the procedures of providing service processing.

The <Invocation Scheme> declares the methods of calling and starting service processing. Incidentally, as the <Invocation Scheme>, there can be used SOAP (Simple Object Access Protocol), SMTP (Simple Mail Transfer Protocol), etc. which are protocols for exchange of, for example, messages.

The <Implicit Elements>, although it is not data which is expressly delivered as an output to a succeeding stage of processing, declares data which can be referred to when executing predetermined processing.

The I/F information registering section 12 stores therein the above-constructed I/F information. And, the I/F information registering section 12, when the power source is turned “on” or every fixed time period, transmits to the service-retrieving server 30 section of the I/F information (for example <Service Class>, <Service Name>, <Service Info Location>, <Input>, and <Output>). Incidentally, the I/F information-registering section 12 may transmits the whole of the I/F information to the service-retrieving server 30.

The service control section 13, for example, displays a list of written-instruction data items on the GUI 14. Here, the GUI 14 needs only to be a type having a function to display, input, edit, etc. and, preferably, is a type that has been constructed using, for example, a touch panel, operation button, etc. Also, the service control section 13, in a case where an item of instruction data has been selected, or a parameter has been input, via the GUI 14, reflects the content thereof in the written instruction and causes the service-providing section 11 to execute the corresponding executable processing that is among them.

The service control section 13, for example, when performing facsimile transmission, causes the service-providing section 11 to execute facsimile transmission, by reading out a transmission destination's FAX number from the FAX number table in the FAX number table storage section 15, so as to cause that section 11 to transmit a facsimile document to the transmission destination. Also, the service control section 13 is placed under the control of the concentrated management server 40. For example, it can also read out a FAX number from the FAX number table storage section 15 or rewrite the FAX number stored in the FAX number table storage section 15.

As illustrated in FIG. 2, the facsimile device 20 has an I/F information registering section 21 that stores therein the I/F information and registers it into the service-retrieving server 30, a FAX number table storage section 22 that stores transmission destination names of the facsimile document original and a FAX number table consisting of a FAX number, etc., and a FAX control section 23 that controls the entire device.

The I/F information registering section 21 stores therein the I/F information that is constructed as illustrated in FIG. 3. And, the I/F information registering section 21, as in the case of the above-described I/F information registering section 12, when the power source is turned on, or every fixed time period, transmits part of the I/F information to the service-retrieving server 30.

The FAX control section 23 reads out a FAX number of the transmission destination from the FAX number table storage section 22 and controls to transmit a facsimile document original to that transmission destination. Also, the FAX control section 23 is placed under the control of the concentrated management server 40, and, for example, can also reads out a FAX number from the FAX number table storage section 22 and rewrite the FAX number stored in the FAX number table storage section 22.

The service-retrieving server 30, in response to a request from the concentrated management server 40, searches for a desired service from among the I/F information that is already registered. Here, the service-retrieving server 30, concretely, as illustrated in FIG. 2, has a registered information storage section 31 that stores therein the I/F information that has been transmitted from the service-processing device such as the composite machine 10, facsimile device 20, etc., a registered information retrieving section 32 that searches for a desired service by using information registered in the registered information storage section 31, and a searched result response section 33 that makes response according to the searched result.

The registered information storage section 31 updates a part or the whole of the I/F information that is transmitted not only from the composite machines 10A, 10B or 10C or facsimile device 20 but also from other service-processing devices, while sequentially storing that. As a result of this, even when a trouble or a change has occurred with respect to the service-processing device, or etc., the registered information storage section 31 can hold at least the gist of the service and the address (URL), regarding all the service-processing devices that are currently connected to the LAN 5 and that are available.

Incidentally, in this embodiment, it has been constructed so that the I/F information regarding the service from the service-processing device such as the composite machine 10 may be registered in the registered information storage section 31. However, it may be constructed so that the services of the service-processing devices that are located on the network in a distributed manner may be searched for and the I/F information regarding those services may be collected.

The concentrated-management server 40, concretely, as illustrated in FIG. 2, has a GUI 41 with respect to which an operator performs his operations or which displays a predetermined list of services, and a management section 42 that manages the information of the respective services on the document processing system 1.

The GUI 41 needs only to be a type which has a function to display, input, edit, etc. and which may be constructed of an ordinary display screen, mouse, keyboard, etc. With respect to the GUI 41, the service that the operator wants to search for is input. Also, the GUI 41 is used when displaying a service list that represents the searched result of the service-retrieving server 30, etc. or inputting a predetermined parameter, etc. as the client terminal.

The management section 42 makes a request to the service-retrieving server 30 so as for it to search for a service that utilizes a common item of information that has been input through the GUI 41. Also, the management section 42 displays on the GUI 41 the searched result that has been transmitted from the service-retrieving server 30. Further, the management section 42 can also collectively update common items of information that are used in the service-processing devices such as the composite machines 10 and facsimile device 20.

In the document-processing system 1 that has been constructed as above, each of the composite machines 10A, 10B, and 10C, facsimile device 20, and computer 25 uses a common FAX number table. And the concentrated-management server 40, in a case where changing the FAX number table that is commonly used in the respective service-processing devices, can collectively update that FAX number table.

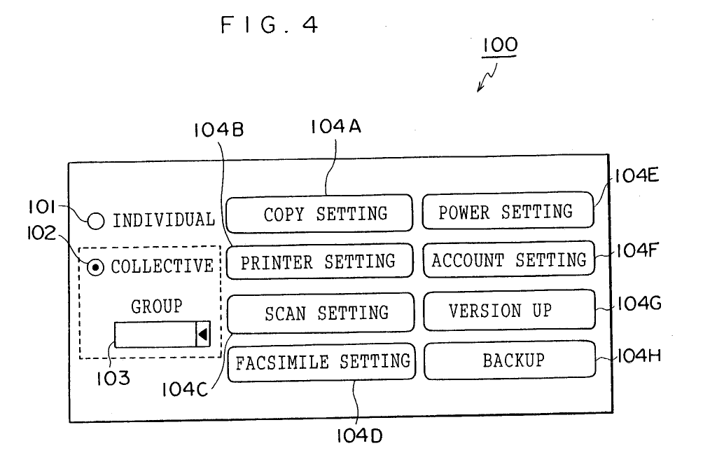

FIG. 4 is a view illustrating a concentrated-management screen 100 that is displayed on the GUI 41 of the concentrated-management server 40. The concentrated-management screen 100 is an operation screen for concentratedly managing the information of the respective service-processing devices provided to the document-processing system 1.

On the concentrated-management screen 100, there are displayed an individual update check box 101 that selects to individually update predetermined items of information, a collective-update check box 102 that selects to collectively update predetermined items of information, a group drop-down box 103 that selects a group that is to be collectively updated, and a plurality of service-setting buttons 104A to 104H. Here, it is assumed that the collective-update check box 102 is already selected. Incidentally, in the following explanation, when displaying any one of the service-setting buttons 104A to 104H, the button is referred to as “the service-setting button 104”.

The group drop-down box 103 is used, when the collective-update check box 102 is selected, to select a group (e.g. the entire company, a predetermined department, or section) that becomes an object to update on the document-processing system 1.

The service-setting buttons 104A to 104H are the buttons that are selected when executing any one of copy setting, printer setting, scan setting, facsimile setting, power setting, account setting, version-up setting, and backup on the document-processing system 1. In this embodiment, an explanation will be given by taking up as an example a case where an operator selects the service setting button 104D.

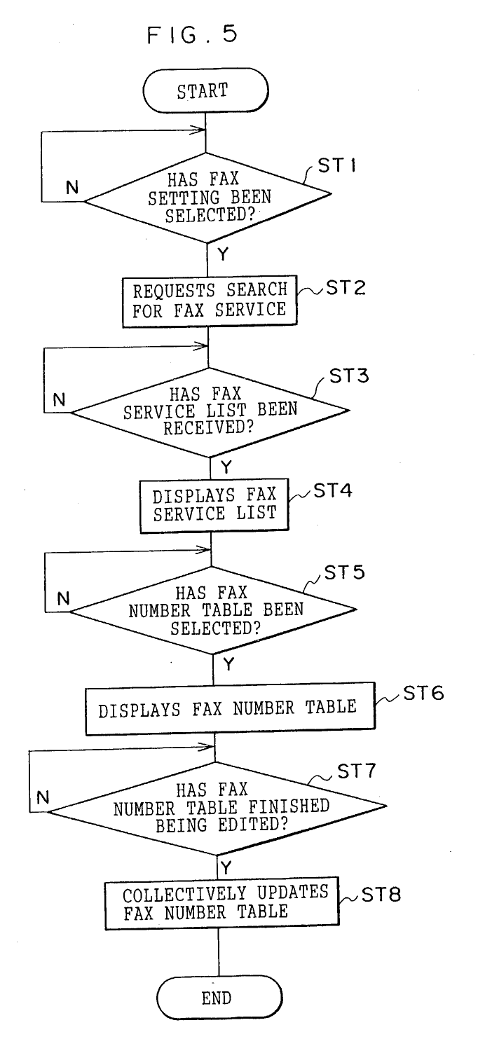

FIG. 5 is a flow chart illustrating an operational procedure of the concentrated-management server 40 when a FAX number table is updated. The management section 42 of the concentrated management server 40 executes processing, illustrated in FIG. 5, from a step ST1 to a step ST8.

In the step ST1, the management section 42 determines whether the service setting button (facsimile setting button) 104D of the concentrated-management screen 100 has been selected. The management section 42 waits until it determines that the facsimile setting button 104 has been selected. When the facsimile setting button 104D is selected, the processing proceeds to the step ST2.

In the step ST2, the management section 42 makes a request to search for the facsimile service, with respect to the service-retrieving server 30, so as for it to search for the service-processing device that performs facsimile service. Then the processing proceeds to the step ST3.

On the other hand, the registered information retrieving section 32 of the service-retrieving server 30, upon its receipt of the request to search for the above-described facsimile service, executes search by using the I/F information recorded in the registered information storage section 31, and searches for the facsimile service that is currently available. Incidentally, the registered information retrieving section 32, as the method of retrieving, may search for a service, for example, the <Service Class> and <Service Name> of which are, respectively, the same between the requested service and the stored service, or may search for a service the <Input> and <Output> of which are, respectively, the same between the requested service and the stored service among information stored in the registered information storage section 31. Further, search may be performed in the way in which the facsimile service itself is input, or a common item of information of “FAX number table” may be searched for.

The search result response section 33, according to the searched-result of the registered information retrieving section 32, produces a list of FAX services that have coincided with the request to search made by the concentrated-management server 40, and also transmits the location information of the respective service-processing devices, together with the FAX service list, to the concentrated-management server 40.

In the step ST3, the management section 42 of the concentrated-management server 40 determines whether it has received the FAX service list that the service-retrieving server 30 has transmitted. And, the management section 42 waits until it has received the FAX service list and, upon its receipt of that FAX service list, has its operation transferred to the step ST4.

In the step ST4, the management section 42 displays the FAX service list screen on the GUI 41, proceeding to the step ST5.

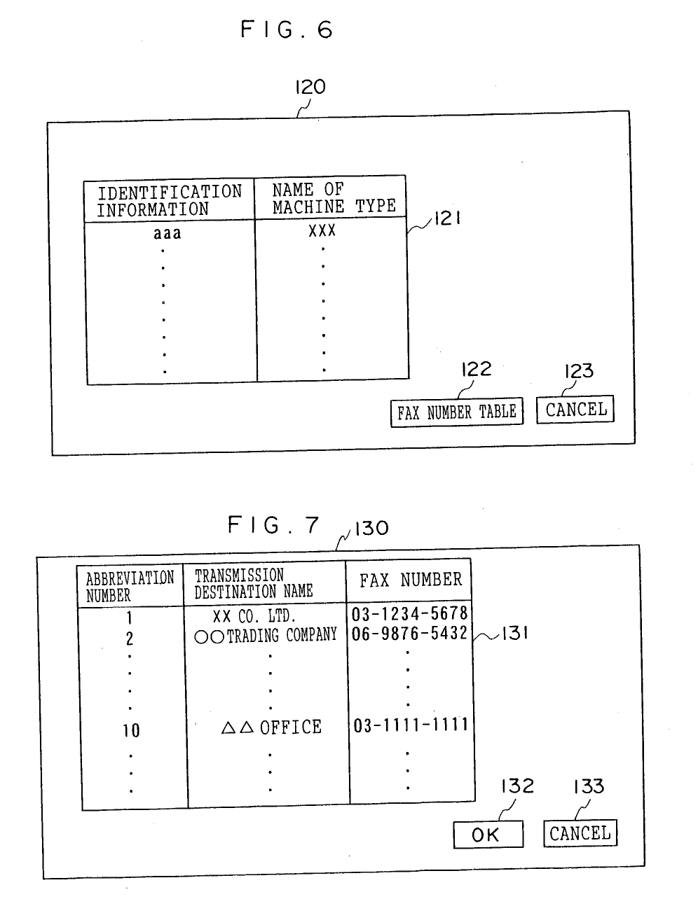

FIG. 6 is a view illustrating a FAX display list screen 120 that has been displayed on the GUI 41. In the FAX display list screen 120, there are displayed a FAX service list 121 that represents the searched result of the service-retrieving server 30, a FAX number display button 122 that instructs displaying the FAX number table, and a cancel button 123 that instructs getting the previous screen back. Here, the FAX number table button 122 is the button for displaying the FAX number table that is used commonly to the respective FAX services.

At this time, for updating only the FAX number tables of partial ones of the FAX services (partial ones of the service-processing devices), the operator may edit the FAX service list 121.

In the step ST5, the management section 42 determines whether the FAX number table button 122 of the FAX display list screen 120 has been selected. And, when having determined that the FAX number table button 122 has been selected, the management section 42 makes a request to transmit the FAX number table with respect to the service-processing device displayed in the FAX service list 121, then the flow proceeds to the step ST6.

On the other hand, the respective service-processing device, upon its receipt of the request to transmit the FAX number table from the concentrated-management server 40, reads out the FAX number table stored in the FAX number table storage section and transmits it to the concentrated-management server 40.

In the step ST6, the management section 42, upon its receipt of the FAX number table transmitted from the respective service-processing device, displays the FAX number table screen on the GUI 41.

FIG. 7 is a view illustrating a FAX number table screen 130 that is displayed on the GUI 41. In the FAX number table screen 130, there are displayed a FAX number table 131 constructed of abbreviation numbers, transmission destination names, and FAX numbers, an “OK” button 132 instructing the end of the editing of the FAX number table 131, and a cancel button 133 instructing getting the previous screen view back. At this time, the operator, by editing the FAX number table 131, can change a transmission destination name or a FAX number of the FAX number table 131.

In the step ST7, the management section 42 determines whether the FAX number table 131 of the FAX number table screen 130 has finished being edited, namely whether the “OK” button 132 has been selected. The management section 42 waits until the “OK” button 132 has been selected and, upon selection of the “OK” button 132, proceeds to the step ST8.

In the step ST8, the management section 42 transmits the data of the FAX number table 131 that is active when the “OK” button 132 has been selected, to the respective service-processing devices displayed in the FAX service list 121, in a format wherein data is described with a method of common description, such as an XML format, based on the format of the I/F information. Then the management section 42 terminates its processing operations. Also, the management section 42 may be constructed so as to produce data for updating in units of a service-processing device and transmit data to the respective service-processing device.

By doing so, the concentrated-management server 40 can collectively update the FAX number table that the respective FAX service device such as the composite machine 10 and facsimile device 20 uses. Incidentally, the concentrated-management server 40 may perform not only collective updating of the FAX number table, as a whole, that is used in the respective service-processing devices, but also changing portions only of the FAX number table.

As described above, the document-processing system 1 can search for a predetermined service (the FAX service in this embodiment) that is currently available, through the operation of the service-retrieving server 30, and display the searched result on the GUI 41 of the concentrated-management server 40. As a result, the operator can confirm the FAX service that is collectively updateable, by looking at the FAX service list 121 displayed on the GUI 41 of the concentrated-management server 40.

Also, since the document-processing system 1 can perform collective updating of the FAX number table commonly used in the respective service-processing devices that are in the FAX service list 121, it is possible to do away with the labor of individually updating the FAX number table ever service-processing device.

Incidentally, the invention is not limited to the above-described embodiment but may be variously changed or modified in terms of the design without departing from the scope of each claim of the invention.

For example, the concentrated-management server 40 can update not only the FAX number used in the FAX service but also, of course, update collectively information commonly used in other services. As the information commonly used in the respective service-processing devices, the concentrated-management server 40, for example, may collectively update addressee information such as electronic mail address, power setting information, user account information defining permission or non-permission of the use of the respective services, etc.

Further, as the service-processing device that is usable in this embodiment, other than those described above, it may be a computer having the so-called direct-facsimiling function, or a composite machine or facsimile device that is connected via a relay server.

What is claimed is:

1. An information updating apparatus comprising:
a service content receiving section for receiving each content of service, which has been transmitted from a plurality of service-processing devices that provide a service for executing a predetermined processing on document data;
a retrieving section for retrieving, based on the content of service that has been received from the service content receiving section, the service-processing device that uses predetermined common information; and
an updating section for collectively updating the common information for the service-processing device that was searched for by the retrieving section.

2. An information updating apparatus according to claim 1, wherein
said retrieving section searches for the service-processing device that uses destination information as the common information.

3. An information updating apparatus according to claim 1, further comprising:
a display section for displaying the common information, which is used by the service-processing device that was searched for by the retrieving section; and
an editing section for editing the common information that was displayed by the display section, wherein
the updating section collectively updates the common information that was edited by the editing section.

4. An information updating apparatus according to claim 2, further comprising:
a display section for displaying the common information, which is used by the service-processing device that was searched for by the retrieving section; and
an editing section for editing the common information that was displayed by the display section, wherein
the updating section collectively updates the common information that was edited by the editing section.

5. An information updating method comprising the steps of:
receiving service content that has been transmitted from each of a respective one of a plurality of service-processing devices that provide a service for executing a predetermined processing on document data;
retrieving, based on the content of service that was received in the service content receiving step, for the service-processing device that uses predetermined common information; and
collectively updating the common information with respect to the service-processing device that was searched for in the retrieving step.

6. An information updating method according to claim 5, wherein
the retrieving step searches for the service-processing device, which uses destination information as the common information.

7. An information updating method according to claim 5, further comprising the steps of:
displaying the common information that is used by the service-processing device, which was searched for in the retrieving step; and
editing the common information, which was displayed in the display step, wherein
the updating step collectively updates the common information that was edited in the editing step.

8. An information updating method according to claim 6, which further comprising the steps of:
displaying the common information that is used by the service-processing device, which was searched for in the retrieving step; and
editing the common information that was displayed in the display step, wherein
the updating step collectively updates the common information that was edited in the editing step.

9. A recording medium for having recorded thereon an information updating control program for causing a computer to execute a processing, which comprises the steps of:
receiving each content of service that has been transmitted from a plurality of service-processing devices that each provide a service for executing a predetermined processing on document data;
retrieving, based on the content of service that has been received in the service content receiving step, for the service-processing device that uses predetermined common information; and
collectively updating the common information with respect to the service-processing device that was searched for in the retrieving step.

10. A recording medium according to claim 9, wherein
the retrieving step searches for the service-processing device that uses destination information as the common information.

11. A recording medium according to claim 9, wherein the processing further comprises the steps of:
displaying the common information that is used by the service-processing device that was searched for in the retrieving step; and
editing the common information that was displayed in the display step, wherein
the updating step collectively updates the common information that was edited in the editing step.

12. A recording medium according to claim 10, wherein the processing further comprises the steps of:
displaying the common information that is used by the service-processing device that was searched for in the retrieving step; and
editing the common information that was displayed in the display step, wherein
the updating step collectively updates the common information that was edited in the editing step.
